(19) United States
(12) Patent Application Publication
(10) Pub. No.: US 2011/0049011 A1
(43) Pub. Date: Mar. 3, 2011

(54) METHOD OF PROCESSING FISCHER-TROPSCH SYNTHETIC OIL TO MANUFACTURE DIESEL FUEL BASE STOCK AND METHOD OF CALCULATING CRACKING RATE UPON HYDROCRACKING WAX FRACTION

(76) Inventor: Yuichi Tanaka, Yokohama-shi (JP)

(21) Appl. No.: 12/735,904

(22) PCT Filed: Mar. 11, 2009
(86) PCT No.: PCT/JP2009/054652

§ 371 Date: Nov. 5, 2010

(30) Foreign Application Priority Data
Mar. 14, 2008 (JP) 2008-065767

(51) Int. Cl. C10G 45/72; G01N 30/02

(52) U.S. Cl. 208/85; 73/23.35

(57) ABSTRACT

An object of the present invention is to provide a method of processing Fischer-Tropsch synthetic oil to manufacture a diesel fuel base stock, the method including: (a) fractionating, in a fractionator, Fischer-Tropsch synthetic oil obtained by a Fischer-Tropsch synthesis method into at least two fractions of a middle fraction containing a component having a boiling point range corresponding to diesel fuel oil and a wax fraction containing a wax component heavier than the middle fraction; (b) bringing the wax fraction into contact with a hydrocracking catalyst in a hydrocracking reactor to obtain a hydrocracked product; (c) separating a gas component from the hydrocracked product to produce hydrocracked oil in a gas-liquid separator disposed in the rear of the hydrocracking reactor used in the step (b); (d) measuring the composition of the gas component separated in the step (c); (e) calculating a cracking rate in the hydrocracking reaction based on the composition of the gas component measured in the step (d); and (f) controlling an operation condition of the hydrocracking reactor so that the cracking rate calculated in the step (e) agrees with an objective cracking rate. Furthermore, another object of the present invention is to provide a method of calculating the cracking rate in hydrocracking the wax fraction obtained by fractionating the Fischer-Tropsch synthetic oil in the fractionator.

### TECHNICAL FIELD

The present invention relates to a method of calculating a cracking rate upon hydrocracking a wax fraction fractionally distilled from Fischer-Tropsch synthetic oil obtained by a Fischer-Tropsch synthesis method (hereinafter, simply referred to as “a FT synthesis method”) using carbon monoxide and hydrogen. Additionally, the present invention relates to a method of controlling the hydrocracking process at the calculated cracking rate.

### BACKGROUND ART

In recent years, from the standpoint of reduction of environmental burdens, there has been a need for a clean liquid fuel which has a low content of sulfur and aromatic hydrocarbons and is compatible with the environment. Thus, in the oil industry, the FT synthesis method has been investigated as a method of manufacturing a clean fuel. The FT synthesis method has high expectations since it can manufacture a liquid fuel base stock which has an abundance of paraffin and which does not contain sulfur, for example, a diesel fuel base stock. For example, Patent Document 1 discloses a fuel oil compatible with the environment.

Patent Document 1: Japanese Unexamined Patent Application, Publication No. 2004-323626

A synthetic oil obtained by the FT synthesis method (hereinafter may be referred to as “FT synthetic oil”) has a broad carbon number distribution. From the FT synthetic oil, it is possible to obtain an FT naphtha fraction containing a number of hydrocarbons having a boiling point of, for example, approximately less than 150° C., an FT middle fraction containing a number of components having a boiling point in the range of from approximately 150° C. to approximately 360° C., and an FT wax fraction containing components heavier than the FT middle fraction.

Furthermore, a substantial quantity of the FT wax fraction is=produced therein. Additionally, there is a concern that the FT middle fraction has insufficient low temperature-performance if the fraction is not processed because the FT middle fraction contains a great quantity of n-paraffins.

Therefore, if such FT wax fraction can be converted to lighter products by way of hydrocracking the FT fraction, this will result in increased production of a diesel fuel.

Accordingly, the FT synthetic oil is fractionated into the FT middle fraction and the FT wax fraction, and the FT middle fraction is hydroisomerized to increase the iso-paraffin content in order to improve its low temperature performance. On the other hand, the FT wax fraction is hydrocracked to convert the FT wax fraction to lighter products, thereby increasing the amount of the middle fraction. Accordingly, a sufficient quantity of a diesel fuel having sufficient performance can be obtained as the middle fraction from FT synthetic oil.

### DISCLOSURE OF THE INVENTION

### Technical Problem

Here, when the hydrocracking reaction of the wax fraction progresses excessively, the hydrocracked product no longer remains in the middle fraction and becomes lighter, and hence the yield of the target middle fraction deteriorates. Therefore, it is required to appropriately control the extent of the reaction by modifying operation conditions in operating the hydrocracking process of the wax fraction.

Accordingly, it is required to appropriately measure the extent of hydrocracking. However, a wax cracking rate measurement is conventionally carried out based on a so-called simulated distillation-gas chromatography. For example such a measurement process takes two hours.

That is, in the conventional measurement method, for example, the wax cracking rate is calculated based on an elution time distribution of hydrocarbons separated and quantified by use of a simulated distillation-gas chromatograph equipped with a nonpolar column and an FID (hydrogen flame ionization detector) at an inlet (raw oil) and at an outlet (produced oil) of a hydrocracking apparatus. Since the total distribution of hydrocarbons is measured in the conventional method, the measurement takes a very long time (approximately two hours). Thus, such a method requiring a long time is not suitable for controlling the process.

Accordingly, the present invention provides a quick and easy method of calculating a cracking rate, and a method of controlling the extent of the hydrocracking based on the calculated cracking rate, in hydrocracking the wax fraction obtained from the FT synthetic oil.

### Technical Solution

In view of the above-described circumstances, the present inventor discovered that the cracking rate in the hydrocracking process can be easily obtained for a short time by the following way. That is, a wax fraction obtained from the FT synthetic oil is hydrocracked, and the composition of predetermined hydrocarbons was determined among the obtained gas fraction, and then the cracking rate of the hydrocracking reaction was calculated based on the composition. Thus, the present invention was achieved based on the discovery.

Specifically, the first aspect of the invention provides the following.

[1] A method of processing Fischer-Tropsch synthetic oil to manufacture a diesel fuel base stock, the method including:

(a) fractionating, in a fractionator, Fischer-Tropsch synthetic oil obtained by a Fischer-Tropsch synthesis method into at least two fractions of a middle fraction containing a component having a boiling point range corresponding to diesel fuel oil and a wax fraction containing a wax component heavier than the middle fraction;

(b) bringing the wax fraction into contact with a hydrocracking catalyst in a hydrocracking reactor to obtain a hydrocracked product;

(c) separating a gas component from the hydrocracked product to produce hydrocracked oil in a gas-liquid separator disposed in the rear of the hydrocracking reactor in the step (b);

(d) measuring the composition of the gas component separated in the step (c);

(e) calculating a cracking rate in the hydrocracking reaction based on the composition of the gas component measured in the step (d); and

(f) controlling an operation condition of the hydrocracking reactor so that the cracking rate calculated in the step (e) agrees with an objective cracking rate.

[2] The method according to [1], wherein the reaction temperature is in a range of 180 to 400° C., the hydrogen partial pressure is in a range of 0.5 to 12 MPa, and the liquid hourly space velocity is in a range of 0.1 to 10.0 h⁻¹ when the wax fraction is brought into contact with the hydrocracking catalyst in the step (b).

[3] The method according to [1] or [2], wherein, in the step (e), the cracking rate in the hydrocracking reaction is calculated based on a content of hydrocarbons having four or less carbon atoms in the measured composition of the gas component.

[4] The method according to any one of [1] to [3], wherein, in the step (e), the cracking rate in the hydrocracking reaction is calculated based on a content of a sum of hydrocarbons having four or less carbon atoms in the measured composition of the gas component.

[5] The method according to any one of [1] to [3], wherein, in the step (e), the cracking rate in the hydrocracking reaction is calculated based on at least one content of normal butane, iso-butane, and propane in the measured composition of the gas component.

[6] The method according to any one of [1] to [5], wherein, in the step (d), a method of measuring the composition of the gas component is gas chromatography.

Furthermore, the second aspect of the invention provides the following.

[7] A method of calculating a cracking rate in hydrocracking a wax fraction obtained by fractionating Fischer-Tropsch synthetic oil in a fractionator, the method including:

(a) hydrocracking the wax fraction;

(b) performing a gas-liquid separation on the hydrocracked product;

(c) measuring a composition of a gas component obtained by the gas-liquid separation; and

(d) calculating a cracking rate in the hydrocracking reaction based on the measured composition of the gas component.

[8] The method according to [7], wherein, in the step (d), the cracking rate in the hydrocracking reaction is calculated based on a content of hydrocarbons having four or less carbon atoms in the measured composition of the gas component.

[9] The method according to [7] or [8], wherein, in the step (d), the cracking rate in the hydrocracking reaction is calculated based on a content of a sum of hydrocarbons having four or less carbon atoms in the measured composition of the gas component.

[10] The method according to [7] or [8], wherein, in the step (d), the cracking rate of the hydrocracking reaction is calculated based on at least one content of normal butane, iso-butane, and propane in the measured composition of the gas component.

[11] The method according to any one of [7] to [10], wherein, in the step (c), a method of measuring the composition of the gas component is gas chromatography.

### Advantageous Effects

The present invention provides a quick and easy method of calculating a cracking rate, and a method of controlling the extent of the hydrocracking based on the calculated cracking rate, in hydrocracking the wax fraction obtained from the FT synthetic oil.

### BRIEF DESCRIPTION OF THE DRAWINGS

FIG. 1 shows a plant for manufacturing diesel fuel base stock including a first fractionator 10 which fractionates FT synthetic oil, a hydrotreating apparatus 30, a hydroisomerizing apparatus 40, and a hydrocracking apparatus 50 which respectively process a naphtha fraction, middle fraction, and wax fraction fractionated in the first fractionator 10.

FIG. 2 shows the hydrocracking apparatus 50 which includes a heat exchanger 56 and gas-liquid separators 55 and 57.

The reference numeral “10” refers to the first fractionator wherein FT synthetic oil is fractionated; the reference numeral “20” refers to the second fractionator wherein products supplied from the hydroisomerizing apparatus 40 and the hydrocracking apparatus 50 are fractionated; the reference numeral “30” refers to a hydrotreating apparatus for the naphtha fraction fractionated in the first fractionator 10; the reference numeral “40” refers to a hydroisomerizing apparatus for the first middle fraction fractionated in the first fractionator 10; the reference numeral “50” refers to a hydrocracking apparatus (hydrocracking reactor) for the wax fraction fractionated in the first fractionator 10; the reference numeral “55” refers to the first gas-liquid separator, the reference numeral “56” refers to a heat exchanger; the reference numeral “57” refers to the second gas-liquid separator; the reference numeral “60” refers to a stabilizer where light gas of a product in the hydrotreating apparatus 30 is extracted from the tower apex; and the reference numeral “70” refers to a naphtha storage tank; the reference numeral “90” refers to a diesel fuel base stock storage tank.

### BEST MODE FOR CARRYING OUT THE INVENTION

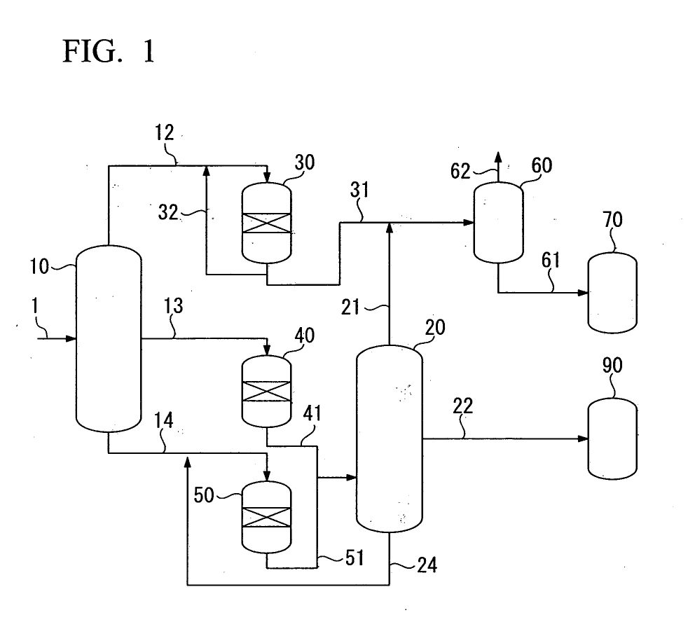

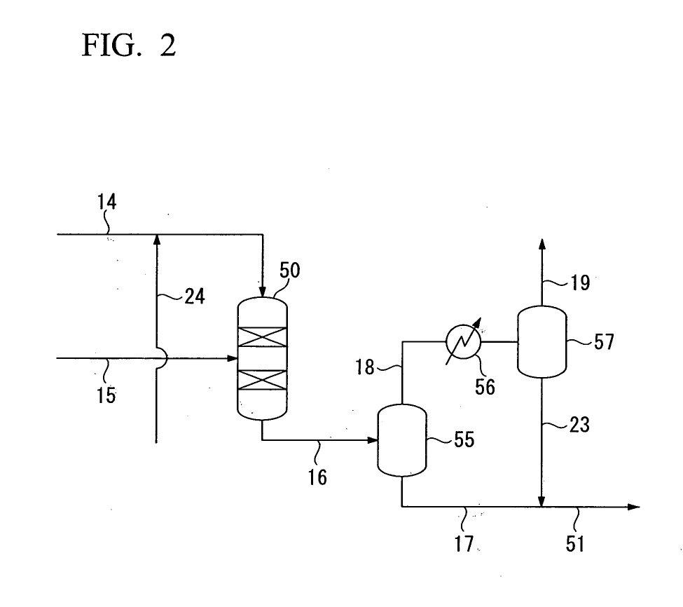

Hereinafter, a plant used to manufacture a diesel fuel base stock of the present invention will be described with reference to FIGS. 1 and 2.

The plant for manufacturing a fuel base stock shown in FIG. 1 includes a first fractionator 10 which fractionates FT synthetic oil supplied from a FT synthesis reactor (not shown) through a line 1. Three types of fractions (i.e. a naphtha fraction, a middle fraction, and a wax fraction) fractionated in the first fractionator 10 are extracted through lines 12, 13, and 14, respectively. Then, each fraction is introduced into a hydrotreating apparatus 30, a hydroisomerizing apparatus 40 or a hydrocracking apparatus (hydrocracking reactor) 50, and is treated therein. Additionally, the area around the hydrocracking apparatus 50 will be described in detail with reference to FIG. 2. Therefore, only a simplified diagram of the manufacture plant is shown in FIG. 1.

The naphtha fraction delivered from the hydrotreating apparatus 30 is supplied to a stabilizer 60 via a line 31. Then, the naphtha fraction is supplied to a naphtha storage tank 70 via a line 61 as naphtha, and is stored therein. Additionally, a part of the naphtha fraction exiting from the hydrotreating apparatus 30 is returned to the line 12 prior to the hydrotreating apparatus 30 via a line 32 so as to be recycled. Gas mainly containing hydrocarbons having four or less carbon atoms is discharged from a top of the stabilizer 60 via a line 62.

The processed materials delivered from the hydroisomerizing apparatus 40 and the hydrocracking apparatus 50 are introduced into a second fractionator 20 via lines 41 and 51. The processed materials are distilled therein, and then, the product is stored in a diesel fuel base stock storing tank 90 (middle fraction tank). Additionally, the bottom oil in the second fractionator 20 is returned to the line 14 prior to the hydrocracking apparatus 50 via a line 24 extending from the bottom of the second fractionator 20 so as to be recycled. The light top fraction in the second fractionator 20 is returned to the line 31 prior to the stabilizer 60 via a line 21, and is introduced into the stabilizer 60.

Additionally, in the figure, a single fraction corresponding to a middle fraction is fractionated in the second fractionator 20, and is extracted via a line 22. However, a plurality of fractions may be fractionated therein. For example, such a middle fraction may be further fractionated into two fractions such as a kerosene fraction and a diesel oil, fraction, or the middle fraction may be fractionated into two or more fractions.

In the first fractionator 10, the FT synthetic oil may be fractionated into three fractions of a naphtha fraction, a kerosene-diesel oil fraction and a wax fraction which may be separated by the boiling points thereof, for example, a boiling point of approximately 150° C. and a boiling point of approximately 360° C. and which are fractionated in that order. A line 1 for introducing the FT synthetic oil, and lines 12, 13 and 14 for delivering fractionated distillates (fractions) to the apparatuses are connected to the first fractionator 10. More specifically, the line 12 is a line that delivers a naphtha fraction fractionated under a temperature of approximately less than 150° C.; the line 13 is a line that delivers a middle fraction fractionated under a temperature in the range of from approximately 150° C. to approximately 360° C.; and the line 14 is a line that delivers a wax fraction fractionated under a temperature of approximately more than 360° C.

### (Fractionation of FT Synthetic Oil)

FT synthetic oil applied to the present invention is not particularly limited as long as the FT synthetic oil is produced by the FT synthesis method. However, it is preferable that the synthetic oil contain 80% by mass or more of a hydrocarbon having a boiling point of approximately 150° C. or higher, and 35% by mass or more of a hydrocarbon having a boiling point of approximately 360° C. or higher, based on the total amount of the FT synthetic oil. The total amount of FT synthetic oil means the sum of hydrocarbons having 5 or more carbon atoms which are produced by the FT synthesis method. For example, the FT synthetic oil may be oil (the content of hydrocarbons having a boiling point of approximately 150° C. or more is 84% by mass, and the content of hydrocarbons having a boiling point of approximately 360° C. or more is 42% by mass where the contents are based on the total amount of the FT synthetic oil (the sum of hydrocarbons having five or more carbon atoms)) produced by the FT synthesis method. Further, the FT synthetic oil loaded from the line 1 is produced by a known FT synthesis reaction. The FT synthetic oil may be fractionated into appropriate fractions as necessary. However, basically, the fractions may have a broad carbon number distribution such as in the FT synthesis.

In the first fractionator 10, at least one cut point may be set to fractionate the FT synthetic oil. Consequently, a fraction of less than the first cut point is obtained as a middle fraction corresponding to a kerosene-gas oil fraction through the line 13 while a fraction of the first cut point or higher is obtained as a bottom oil (heavy wax component) corresponding to a wax fraction through the line 14.

With regard to the number of cut points set in the first fractionator 10, at least two cut points may be preferably set to fractionate the FT synthetic oil. Consequently, a fraction of less than the first cut point is obtained as a naphtha light fraction through the line 12; a fraction of the first cut point to the second cut point is obtained as a middle fraction corresponding to a gas oil fraction through the line 13; and a fraction of more than the second cut point is obtained as tower bottom oil (heavy wax component) corresponding to a wax fraction through the line 14.

The naphtha fraction is transferred to the hydrotreating apparatus 30 via the line 12 so as to be subjected to a hydrogenation process therein.

The middle fraction corresponding to a kerosene-diesel oil fraction is transferred to the hydroisomerizing apparatus 40 via the line 13 so as to be subjected to a hydroisomerizing process therein.

The wax fraction exits from the line 14 and is transferred to the hydrocracking apparatus 50 so as to be subjected to a hydrocracking process.

The product treated in the hydrotreating apparatus 30 is extracted through the line 31, and is supplied to the stabilizer 60. The gas component is discharged from the top of the stabilizer 60 (not shown). The naphtha fraction is supplied from the bottom of the stabilizer 60 to the naphtha storage tank 70 via the line 61, and is stored therein.

Since a substantial quantity of n-paraffins is contained in the middle fraction obtained from the FT synthetic oil, low temperature properties (such as low-temperature flowability) thereof may be insufficient. Therefore, the middle fraction is hydroisomerized to improve the low temperature properties.

The middle fraction obtained from the line 13 is treated in the hydroisomerizing apparatus 40. The hydroisomerizing method may be a known method.

The product from the hydroisomerizing apparatus 40 is delivered to the second fractionator 20 via the line 41. In the same manner, the product from the hydrocracking apparatus 50 described below is delivered to the second fractionator 20 via a line 51.

The wax fraction is extracted from the bottom line 14 of the first fractionator 10. The amount of wax fraction obtained by fractionating the FT synthetic oil is considerable. Therefore, the wax fraction is hydrocracked to obtain a fraction corresponding to the middle fraction, and is recycled to increase the production of the middle fraction.

The decomposition of the wax corresponds to hydrocracking. Such hydrocracking is preferable since the reaction converts olefins or alcohols, which may be included in the wax fraction, into paraffins. Additionally, the hydrocracking process is mainly carried out to hydrocrack the wax fraction into the middle fraction. However, a part of the wax fraction is further hydrocracked, thereby producing, for example, a small amount of gas components having four or less carbon atoms such as n-butane, iso-butane, propane, ethane, and methane. That is, in the hydrocracking reaction of the wax fraction in the present invention, hydrocarbons having four or less carbon atoms are by-products.

In the second fractionator 20, the hydroisomerized product and the hydrocracked product are mixed and fractionated. A light fraction is transferred to a naphtha fraction system via the line 21, and the middle fraction is collected from the line 22 as one of “second middle fractions”, and is stored in the diesel fuel base stock storing tank 90. The method of mixing the hydroisomerized product and the hydrocracked product is not particularly limited. For example, tank blending or line blending may be adopted.

As described above, the fraction corresponding to the middle fraction may be fractionated into plural fractions. For example, the fraction may be fractionated into two fractions of fractions corresponding to kerosene and diesel oil, or two or more fractions.

A bottom component of the second fractionator 20 is recycled through the line 24 previous to the hydrocracking apparatus 50 for the wax fraction, and is subjected to the hydrocracking reaction again to increase a decomposition yield.

### <Hydrocracking of Wax Fraction>

Examples of the hydrocracking catalyst used in hydrocracking apparatus 50 include a carrier of a solid acid onto which an active metal belonging to Group VIII in the periodic table is loaded.

Preferable examples of such a carrier include a carrier containing a crystalline zeolite such as ultra-stable Y type (USY) zeolite, HY zeolite, mordenite, or β-zeolite one; and at least one solid acid selected from amorphous metal oxides having heat resistance, such as silica alumina, silica zirconia or alumina boria. Moreover, it is preferable that the carrier be a carrier containing USY zeolite; and at least one solid acid selected from silica alumina, alumina boria, and silica zirconia. Furthermore, a carrier containing USY zeolite and silica alumina is more preferable.

USY zeolite is a Y-type zeolite that is ultra-stabilized by way of a hydrothermal treatment and/or acid treatment, and fine pores within a range of 20 Å to 100 Å are formed in addition to a micro porous structure, which is called micropores of 20 Å or less originally included in Y-type zeolite. When USY zeolite is used for the carrier of the hydrocracking catalyst, its average particle diameter is not particularly limited. However, the average particle diameter thereof is preferably 1.0 μm or less, or more preferably 0.5 μm or less. In USY zeolite, a molar ratio of silica/alumina (i.e. molar ratio of silica to alumina; hereinafter referred to as “silica/alumina ratio”) is preferably within a range of 10 to 200, more preferably within a range of 15 to 100, and the most preferably within a range of 20 to 60.

It is preferable that the carrier include 0.1% to 80% by mass of a crystalline zeolite and 0.1% to 60% by mass of a heat-resistant amorphous metal oxide.

A mixture including the above-mentioned solid acid and a binder may be subjected to moulding, and the moulded mixture may be calcined to produce the catalyst carrier. The blend ratio of the solid acid therein is preferably within a range of 1% to 70% by mass, or more preferably within a range of 2% to 60% by mass with respect to the total amount of the carrier. If the carrier includes USY zeolite, the blend ratio of USY zeolite is preferably within a range of 0.1% to 10% by mass, or more preferably within a range of 0.5% to 5% by mass to the total amount of the carrier. If the carrier includes USY zeolite and alumina-boria, the mixing ratio of USY zeolite to alumina-boria (USY zeolite/alumina-boria) is preferably within a range of 0.03 to 1 based on a mass ratio. If the carrier includes USY zeolite and silica alumina, the mixing ratio of USY zeolite to silica alumina (USY zeolite/silica alumina) is preferably within a range of 0.03 to 1 based on a mass ratio.

The binder is not particularly limited. However, the binder is preferably alumina, silica, silica alumina, titania, or magnesia, and is more preferably alumina. The blend ratio of the binder is preferably within a range of 20% to 98% by mass, or more preferably within a range of 30% to 96% by mass based on the total amount of the carrier.

The calcination temperature of the mixture is preferably within a range of 400° C. to 550° C., more preferably within a range of 470° C. to 530° C., or particularly preferably within a range of 490° C. to 530° C.

Examples of the group VIII metal include cobalt, nickel, rhodium, palladium, iridium, platinum and the like. In particular, metal selected from nickel, palladium and platinum is preferably used singularly or in combination of two or more kinds.

These kinds of metal may be loaded on the above-mentioned carrier according to a common method such as impregnation, ion exchange or the like. The total amount of the loaded metal is not particularly limited. However, the amount of the loaded metal is preferably within a range of 0.1% to 3.0% by mass with respect to the carrier.

Hydrocracking the wax fraction may be performed under the following reaction conditions. That is, the hydrogen partial pressure may be within a range of 0.5 MPa to 12 MPa, or preferably within a range of 1.0 MPa to 5.0 MPa. Liquid hourly space velocity (LHSV) of the wax fraction may be within a range of 0.1 h⁻¹ to 10.0 h⁻¹, or preferably within a range of 0.3 h⁻¹ to 3.5 h⁻¹. The hydrogen/oil ratio is not particularly limited, but may be within a range of 50 NL/L to 1000 NL/L, preferably within a range of 70 NL/L to 800 NL/L.

Additionally, “LHSV (liquid hourly space velocity)” refers to a volume flow rate of feedstock per volume of a catalyst bed filled with catalyst under standard conditions (25° C. and 101,325 Pa), and the unit “h⁻¹” represents the reciprocal of hours. “NL” being the unit of hydrogen volume in the hydrogen/oil ratio represents hydrogen capacity (L) under normal conditions (0° C. and 101,325 Pa).

The reaction temperature for hydrocracking (weight average temperature of a catalyst bed) may be within a range of 180° C. to 400° C., preferably within a range of 200° C. to 370° C., more preferably within a range of 250° C. to 350° C., particularly preferably 280° C. to 350° C. If the reaction temperature for hydrocracking exceeds 400° C., not only may the yield of the middle fraction remarkably decrease, but the product may also be colored, thereby limiting use of the product as a fuel base stock. Accordingly, if such a problem arises, the reaction temperature can be adjusted to the above-mentioned temperature range. If the reaction temperature is less than 180° C., alcohols may be insufficiently removed, and may remain therein. If such a problem arises, the reaction temperature can be adjusted to the above-mentioned temperature range in the same manner.

A cracking rate in the hydrocracking reaction may be modified by adjusting the reaction conditions such as the hydrogen partial pressure, the LHSV, the hydrogen/oil ratio or the cracking temperature other than selection of a catalyst.

Additionally, in the hydrocracking process, if reaction conditions for hydrocracking are adjusted such that hydrocracked products having five or more carbon atoms and a boiling point of approximately less than 360° C. present in the hydrocracked oil flowed out from the hydrocracking apparatus 50 is form 20% by mass to 90% by mass, preferably from 30% by mass to 80% by mass; and more preferably from 45% by mass to 70% by mass based on the weight of hydrocarbons introduced into the hydrocracking apparatus 50, the yield of the target middle fraction will increase. Therefore, such adjustment of the reaction conditions is preferable.

Next, the hydrocracking operation will be described in more detail with reference to FIG. 2.

The wax fraction present in the bottom of the first fractionator 10 is introduced into the hydrocracking apparatus (hydrocracking reactor) 50 via the line 14, and is hydrocracked. As the hydrocracking apparatus 50, a known fixed-bed reactor may be used. In this embodiment, a fixed-bed reactor is filled with a predetermined hydrocracking catalyst, and hydrogen gas (H₂) is introduced thereinto via the line 15 to hydrocrack the wax fraction. Preferably, the heavy fraction extracted from the bottom of the second fractionator 20 is delivered back to the line 14 via the line 24, and the heavy fraction is hydrocracked in the hydrocracking apparatus 50 with the wax fraction from the first fractionator 10.

The hydrocracked product is extracted from the bottom of the hydrocracking apparatus 50 via a line 16, and is introduced into the first gas-liquid separator 55 disposed in the rear of the hydrocracking apparatus 50. Subsequently, a liquid component resulting from the gas-liquid separation is extracted via a line 17 while a hydrocracked gas component is extracted via a line 18. The hydrocracked gas component obtained via the line 18 is cooled by a heat exchanger 56, is further introduced into a second gas-liquid separator 57, and is subjected to the gas-liquid separation therein. Then, a gas component produced in the second gas-liquid separator 57 is extracted from the system through a line 19 while a liquid component is extracted through a line 23 that is connected to the line 17. Subsequently, the combined liquid component is transferred to the second fractionator 20 via the line 51 as hydrocracked oil.

With regard to measurement of composition of the hydrocracked gas component, a hydrocracked gas component is extracted from the second gas-liquid separator 57 through the line 19, and the composition of extracted gas is measured.

That is, a portion of the hydrocracked gas component is sampled in the line 19, and is analyzed by use of a gas chromatograph. In this way the content (% by mass) of hydrocarbons having four or less carbon atoms in the hydrocracked gas component is determined.

Specifically, the content of hydrocarbons having four or less carbon atoms in the hydrocracked gas component is calculated based on total composition analysis results of hydrocarbons having four or less carbon atoms separated and quantified by use of a gas chromatograph equipped with a nonpolar column and an FID (hydrogen flame ionization detector) where a predetermined temperature program and He as carrier gas are used. This composition analysis can be completed twenty minutes after injecting the hydrocracked gas component into the gas chromatograph.

Additionally, for the reference, the cracking rate of the wax fraction (wax cracking rate) is separately obtained using simulated distillation-gas chromatography according to a known method.

More specifically, the cracking rate of the wax fraction is obtained based on an elution time distribution obtained by simulated distillation-gas chromatography at the inlet (raw oil) or at the outlet (produced oil) of the hydrocracking apparatus. That is, the total fraction of hydrocarbons is eluted by use of the gas chromatograph equipped with the nonpolar column and the FID (hydrogen flame ionization detector) using a predetermined temperature program and helium gas or nitrogen gas as the carrier gas. Then, the wax cracking rate is obtained based on the obtained elution time distribution.

In this case, when the elution time distribution obtained with respect to the raw oil or the produced oil is compared with an elution time distribution with respect to a sample which contains a reagent component whose boiling point is known whereby the content (% by mass) of components having the boiling point or higher, and the content (% by mass) of components having a lower boiling point.

Then, the wax cracking rate is calculated by the following equation.

The cracking rate (% by mass)=[(a content (% by mass) of a component having a certain boiling point or higher in raw oil−a content (% by mass) of a component having the boiling point or higher in produced oil)]/(the content (% by mass) of the component having the boiling point or higher in the raw oil)×100

Additionally, it is required to cool the analysis system for approximately 20 to 30 minutes after the completion of composition analysis to conduct the next composition analysis after the completion of composition analysis. Accordingly, it takes one and a half to two hours to carry out a series of procedures from the start of one sample analysis to the start of next sample analysis.

With regard to the above-described wax cracking rate, the raw material of wax has a considerably broad composition distribution in general as described above. Moreover, components having a hydrocarbon linkage type such as a straight chain or a branch are mixed therein.

Accordingly, if the total composition distribution including hydrocarbon linkage types is obtained before and after the hydrocracking process and the results are compared, a highly precise wax cracking rate will be obtained. However, such a method is more difficult than the known method of calculating the wax cracking rate by use of simulated distillation-gas chromatography.

Accordingly, in general, a certain boiling point is predetermined as described in the above equation, and a rate of simple reduction in heavy components having the predetermined boiling point or higher is used instead of the wax cracking rate.

It is sufficient for practical use that the cracking rate be represented by the rate of simple reduction in heavy components shown in the above-described equation. Conventionally, the wax cracking rate has been represented by such an equation regardless of whether a value adopted for the predetermined boiling point is appropriate or not.

Therefore, such a conventional wax cracking rate will be explained based on the above-described rate of simple reduction in heavy components. However, in the present invention, the conventional wax cracking rate is only used to obtain the prediction equation described below, and the simple reduction rate is not used after obtaining the prediction equation. Additionally, the above-mentioned precise wax cracking rate may be obtained based on the composition distribution, and the precise wax cracking rate may be used to obtain the prediction equation described below without any problem.

The cracking rate in the hydrocracking reaction is predicted from the obtained content (% by mass) of the hydrocarbons having four or less carbon atoms in the hydrocracked gas component based on the following Equation 1.

(Equation 1) . . . a method wherein the cracking rate is calculated from the hydrocarbons (C₄—) having four or less carbon atoms.

Y=−3.455×X²+40.933×X

(Y: the cracking rate, X: the total content of all hydrocarbons having four or less carbon atoms)

As described below, it is possible to highly precisely predict the wax cracking rate even based on a content of any one of hydrocarbons having four or less carbon atoms. Accordingly, in the invention, “the content of hydrocarbons having four or less carbon atoms” means a content of any one of hydrocarbons having four or less carbon atoms, or a content of the sum of several hydrocarbons having four or less carbon atoms.

Furthermore, in the case where “the wax cracking rate (the cracking rate in the hydrocracking reaction) is calculated based on the content of hydrocarbons having four or less carbon atoms” in the present invention, the wax cracking rate may be calculated from the content of the sum of hydrocarbons having four or less carbon atoms, or the wax cracking rate may be calculated from at least one of the hydrocarbons having four or less carbon atoms as described below. In this case, the cracking rate may be calculated based on each of hydrocarbons having four or less carbon atoms, and an average value thereof may be obtained.

However, it is preferable that the method of prediction using the above-described Equation 1 based on the content of the sum of hydrocarbons having four or less carbon atoms be adopted.

(Equation 2) . . . a method wherein the cracking rate is calculated from a content of normal butane (nC₄).

Y=−85.012×X²+199.5×X

(Y: the cracking rate, X: the content of nC₄)

(Equation 3) . . . a method wherein the cracking rate is calculated from a content of iso-butane (iso-C₄).

Y=−15.958×X²+84.707×X

(Y: the cracking rate, X: the content of iso-C₄)

(Equation 4) . . . a method wherein the cracking rate is calculated from a content of propane (C₃).

Y=−54.235×X²+155.59×X

(Y: the cracking rate, X: the content of C₃)

Specifically, the above-described prediction equations are formulas derived from a relationship between the wax cracking rate separately obtained from the wax cracking rate equation and the content of hydrocarbons having four or less carbon atoms.

Since the predicted cracking rate obtained as described above substantially agrees with the cracking rate obtained by the conventional method, the wax cracking rate can be obtained with high precision in a short time.

Then, operation conditions in the hydrocracking process is appropriately controlled based on the predicted cracking rate, it is possible to operate the hydrocracking process of the wax fraction at an appropriate cracking rate. Specifically, “to control the operation conditions of the hydrocracking process” means that parameters such as a catalyst type, hydrogen partial pressure, liquid hourly space velocity (LHSV), hydrogen/oil ratio, the reaction temperature or the like in the hydrocracking process are appropriately adjusted as described above.

The above-described Equations 1 to 4 are equations for estimating the wax cracking rate that are recursively formulated by the inventor based on the relationship between the content of hydrocarbons having four or less carbon atoms and the actual wax cracking rate obtained from the results of the simulated distillation gas chromatography (where the predetermined boiling point temperature is set to 360° C. in the equation for calculating the above-described wax cracking rate) with respect to the produced oil and the raw oil in the hydrocracking process of the wax fraction.

Additionally, the equation for predicting the wax cracking rate varies with the predetermined boiling point (wax cracking index) in the simulated distillation-gas chromatography. With regard to the above-described prediction equation, the boiling point is set to 360° C. as one example thereof. However, cracking rate may be obtained by the simulated distillation-gas chromatography with respect to each boiling point while the content of hydrocarbons having four or less carbon atoms in the hydrocracked gas component may be obtained by the gas chromatograph whereby an optimal prediction equation can be determined based on the relationship between the cracking rate obtained by the simulated distillation-gas chromatography and the content of hydrocarbons having four or less carbon atoms obtained by the gas chromatograph to use the prediction equation in controlling the hydrocracking reaction.

### EXAMPLES

Hereinafter, the present invention will be described in more detail with reference to Examples. However, the present invention is not limited to Examples.

### <Preparation of Catalyst>

### (Catalyst A)

Silica alumina (molar ratio of silica/alumina:14), and an alumina binder were mixed and kneaded at a weight ratio of 60:40, and the mixture was moulded into a cylindrical form having a diameter of approximately 1.6 mm and a length of approximately 4 mm. Then, this was calcined at 500° C. for one hour, thereby producing a carrier. The carrier was impregnated with a chloroplatinic acid aqueous solution to support platinum on the carrier. The impregnated carrier was dried at 120° C. for 3 hours, and then, calcined at 500° C. for one hour, thereby producing catalyst A. The amount of platinum loaded on the carrier was 0.8% by mass to the total amount of the carrier.

### (Catalyst B)

USY zeolite (molar ratio of silica/alumina:37) having an average particle diameter of 1.1 silica alumina (molar ratio of silica/alumina:14) and an alumina binder were mixed and kneaded at a weight ratio of 3:57:40, and the mixture was moulded into a cylindrical form having a diameter of approximately 1.6 mm and a length of approximately 4 mm. Then, this was calcined at 500° C. for one hour, thereby producing a carrier. The carrier was impregnated with a chloroplatinic acid aqueous solution to support platinum on the carrier. The impregnated carrier was dried at 120° C. for 3 hours, and then, calcined at 500° C. for one hour, thereby producing catalyst B. The amount of platinum loaded on the carrier was 0.8% by mass to the total amount of the carrier.

### Examples 1 to 9

### <Manufacture of Diesel Fuel>

### (Fractionation of FT Synthetic Oil)

In the first fractionator, oil produced by a FT synthesis method (i.e. FT synthetic oil) (the content of hydrocarbons having a boiling point of approximately 150° C. or higher was 84% by mass, and the content of hydrocarbons having a boiling point of approximately 360° C. or higher was 42% by mass, based on the total amount of the FT synthetic oil (corresponding to the sum of hydrocarbons having 5 or more carbon atoms)) was fractionated into a naphtha fraction having a boiling point of approximately less than 150° C., a first middle fraction having a boiling point in the range of from approximately 150° C. to approximately 350° C. and a wax fraction as a bottom fraction.

### (Hydroisomerization of First Middle Fraction)

The hydroisomerizing reactor 40, which is a fixed-bed flow reactor, was filled with the catalyst A (150 ml), the above-Obtained middle fraction was supplied thereto from the tower apex of the hydroisomerizing reactor at a rate of 225 ml/h, and the middle fraction was hydrogen-treated in a hydrogen stream under reaction conditions shown in Table 1 to obtain a hydroisomerized product (line 41).

That is, hydrogen was supplied from the tower apex at a hydrogen/oil ratio of 338 NL/L to the middle fraction, and the reactor pressure was adjusted with a back pressure valve, such that the inlet pressure remained constant at 3.0 MPa, and the hydroisomerization reaction was conducted. At that time, the reaction temperature was 308° C.

### (Hydrocracking of Wax Fraction)

A reactor of the hydrocracking apparatus 50, which is a fixed-bed flow reactor, was filled with the catalyst B (150 ml). Then, the wax fraction was hydrocracked under reaction conditions shown in Table 1 to obtain a hydrocracked product (line 16).

That is, the wax fraction obtained from the bottom of the first fractionator 10 was supplied to the top of the reactor 50 at a speed of 150 or 300 ml/h while hydrogen was also supplied thereto from the top of the reactor 50 at a hydrogen/oil ratio of 676 NL/L with respect to the wax fraction, and the back pressure valve was adjusted so that the inlet pressure was constantly maintained at 3.0 or 4.0 MPa. Thus, the wax fraction was hydrocracked in the above-described conditions. At this time, the reaction temperature was in the range of 304 to 329° C. Additionally, the conditions for each example are described in Table 1.

### (Analysis of Hydrocarbon Having Four or Less Carbon Atoms and Raw Oil/Produced Oil)

The hydrocracked product supplied from the line 16 was subjected to gas-liquid separation in the first gas-liquid separator 55 disposed in the rear of the hydrocracking apparatus 50. Subsequently, the produced oil was extracted via the line 17. The hydrocracked gas component supplied from line 18 was cooled by the heat exchanger 56, and then, was introduced into the second gas-liquid separator 57 to further perform the gas-liquid separation thereon. The separated liquid component was extracted via the line 23 to be combined in the line 17 whereby the hydrocracked oil was obtained via the line 51, and was introduced into the second fractionator. On the other hand, the hydrocracked gas component was extracted via the line 19, and was analyzed with a gas chromatograph so as to measure the cracking rate of the produced oil and the content (% by mass) of hydrocarbons having four or less carbon atoms in the hydrocracked gas component.

The cracking rate of the wax fraction was obtained by the above-described simulated distillation-gas chromatography. That is, all fractions of hydrocarbons in the raw oil at the inlet of the hydrocracking apparatus or in the hydrocracked oil (produced oil) obtained via the line 51 was eluted in the gas chromatograph (SHIMADZU Corporation GC-14B) equipped with a nonpolar column (OV-101) and an FID (hydrogen flame ionization detector), using a predetermined temperature program and helium as carrier gas whereby the cracking rate was obtained based on results of the elution time distribution.

Specifically, the raw oil or the produced oil (these are referred to as “an analysis sample”) was heated to 80° C. to 120° C. in a thermostat bath in advance so as to be in a liquid state. With regard to the column temperature program in the gas chromatograph, the temperature was maintained at 30° C. for ten minutes from the analysis start by the sample injection to prevent an excessive amount of volatile components included in the sample from evaporating at the initial stage of analysis, and then, the temperature was increased up to 360° C. at a speed of 10° C./minute. Then, the temperature was maintained at 360° C. for thirty minutes.

The elution time distribution obtained with respect to the analysis sample was compared with the elution time distribution to the sample of mixed reagent components having a known boiling point to obtain the content (% by mass) of components having a boiling point of 360° C. or higher and the content (% by mass) of components having a boiling point less than 360° C. Then, the wax tracking rate was obtained by the following equation.

The cracking rate (% by mass)=[(the content (% by mass) of components having the boiling point of 360° C. or higher in the raw oil−the content (% by mass) of components having a boiling point of 360° C. or higher in the produced oil)]/(the content (% by mass) of components having a boiling point of 360° C. or higher in the raw oil)×100

The required time for the measurement was approximately two hours. The result is shown as the actual cracking rate in Table 2.

The content of hydrocarbons having four or less carbon atoms in the hydrocracked gas component was calculated based on results of the total composition analysis of hydrocarbons having four or less carbon atoms separated and quantified with the gas chromatograph (Agilent Technologies, 7890A, GC system) equipped with a nonpolar column (HP-PLOT AI₂O₃) and an FID (hydrogen flame ionization detector), using a predetermined temperature program and He as carrier gas. The required time was approximately twenty minutes.

The cracking rate in the hydrocracking reaction was predicted from the content (% by mass) of the sum of hydrocarbons having four or less carbon atoms in the hydrocracked gas component based on the above-described Equation 1. The results are shown in Table 2.

### (Fractionation of Hydroisomerized Product and Hydrocracked Product)

The hydroisomerized product (isomerized middle fraction: line 41) of the middle fraction and the hydrocracked product (wax cracked fraction: line 51) of the wax fraction were blended in the line at a ratio of 1:1 (% by mass), and the mixture was fractionated in the second fractionator 20. Accordingly, a kerosene fraction (the boiling point in the range of from approximately 150 to approximately 250° C.) and a gas oil fraction (the boiling point in the range of from approximately 250 to approximately 350° C.) were extracted as diesel fuel base stocks, and were appropriately mixed to manufacture a diesel fuel.

The bottom component in the second fractionator 20 was continuously returned to the line 14 at the inlet of the hydrocracking apparatus 50 via the line 24 so as to be subjected to the hydrocracking process again.

Additionally, the top component in the second fractionator 20 was extracted via the line 21 so as to be introduced into the line 31 of the hydrotreating apparatus 30, and was introduced into the stabilizer 60.

With regard to Examples 1 to 9, the cracking rate based on actually measured value with respect to the produced oil agreed well with the cracking rate predicted from the content of the sum of hydrocarbons having four or less carbon atoms in the hydrocracked gas component. Thus, it was evident that the wax cracking rate was predicted with high precision in a short time even if the operation conditions were different.

For example, when the catalyst B is filled into the fixed-bed flow reactor of the hydrocracking apparatus and the hydrocracking rate of the wax fraction is adjusted to 50% by mass, it can be understood that the content (% by mass) of hydrocarbons having four or less carbon atoms in the hydrocracked gas component be 1.38 in terms of the calculation based on the above-described Equation 1.

Accordingly, if the reaction temperature is controlled so that the content (% by mass) of hydrocarbons having four or less carbon atoms in the hydrocracked gas component (i.e. as results of the analysis on hydrocracked gas) agrees with the above-described value without analyzing the produced oil, then, the cracking rate becomes 50% by mass. Accordingly, the operation can be controlled quickly to achieve a objective cracking rate.

TABLE 1

| | | | EXAMPLE 1 | EXAMPLE 2 | EXAMPLE 3 | EXAMPLE 4 | EXAMPLE 5 |
|---|---|---|---|---|---|---|---|
| CONDITION FOR | CATALYST | | CATALYST A | ← | ← | ← | ← |
| HYDROISOMERIZING | LHSV | h⁻¹ | 1.5 | ← | ← | ← | ← |
| MIDDLE FRACTION | REACTION | ° C. | 308 | ← | ← | ← | ← |
| | TEMPERATURE | | | | | | |
| | HYDROGEN | MPa | 3.0 | ← | ← | ← | ← |
| | PARTIAL | | | | | | |
| | PRESSURE | | | | | | |
| | HYDROGEN/OIL | NL/L | 338 | ← | ← | ← | ← |
| | RATIO | | | | | | |
| CONDITION FOR | CATALYST | | CATALYST B | CATALYST B | CATALYST B | CATALYST B | CATALYST B |
| HYDROCRACKING | LHSV | h⁻¹ | 2.0 | 2.0 | 2.0 | 1.0 | 1.0 |
| WAX FRACTION | REACTION | ° C. | 319 | 324 | 329 | 304 | 309 |
| | TEMPERATURE | | | | | | |
| | HYDROGEN | MPa | 4.0 | 4.0 | 4.0 | 4.0 | 4.0 |
| | PARTIAL | | | | | | |
| | PRESSURE | | | | | | |
| | HYDROGEN/OIL | NL/L | 676 | 676 | 676 | 676 | 676 |
| | RATIO | | | | | | |

| | | | EXAMPLE 6 | EXAMPLE 7 | EXAMPLE 8 | EXAMPLE 9 |
|---|---|---|---|---|---|---|
| CONDITION FOR | CATALYST | | ← | ← | ← | ← |
| HYDROISOMERIZING | LHSV | h⁻¹ | ← | ← | ← | ← |
| MIDDLE FRACTION | REACTION | ° C. | ← | ← | ← | ← |
| | TEMPERATURE | | | | | |
| | HYDROGEN | MPa | ← | ← | ← | ← |
| | PARTIAL | | | | | |
| | PRESSURE | | | | | |
| | HYDROGEN/OIL | NL/L | ← | ← | ← | ← |
| | RATIO | | | | | |
| CONDITION FOR | CATALYST | | CATALYST B | CATALYST B | CATALYST B | CATALYST B |
| HYDROCRACKING | LHSV | h⁻¹ | 1.0 | 2.0 | 2.0 | 2.0 |
| WAX FRACTION | REACTION | ° C. | 314 | 313 | 318 | 323 |
| | TEMPERATURE | | | | | |
| | HYDROGEN | MPa | 4.0 | 3.0 | 3.0 | 3.0 |
| | PARTIAL | | | | | |
| | PRESSURE | | | | | |
| | HYDROGEN/OIL | NL/L | 676 | 676 | 676 | 676 |
| | RATIO | | | | | |

TABLE 2
PREDICTED VALUE OF CRACKING RATE AND CONTENT OF HYDROCARBON IN HYDROCRACKED GAS COMPONENT

| | | | | EXAMPLE 1 | EXAMPLE 2 | EXAMPLE 3 | EXAMPLE 4 | EXAMPLE 5 |
|---|---|---|---|---|---|---|---|---|
| CONTENT | CONTENT OF SUM OF | (C4−) | mass % | 1.49 | 2.00 | 2.61 | 0.89 | 1.19 |
| OF | HYDROCARBONS | | | | | | | |
| HYDROCARBON | HAVING FOUR OR | | | | | | | |
| | LESS CARBON ATOMS | | | | | | | |
| | NORMAL BUTANE | (nC4) | mass % | 0.31 | 0.42 | 0.54 | 0.18 | 0.25 |
| | ISO-BUTANE | (iC4) | mass % | 0.73 | 0.99 | 1.30 | 0.43 | 0.58 |
| | PROPANE | (C3) | mass % | 0.39 | 0.52 | 0.73 | 0.23 | 0.33 |

| | | | | | | |
|---|---|---|---|---|---|---|
| CRACKING RATE ESTIMATED FROM | mass % | 53.4 | 68.2 | 83.5 | 33.8 | 43.9 |
| HYDROCARBONS HAVING FOUR OR | | | | | | |
| LESS CARBON ATOMS*¹ | | | | | | |
| ACTUAL CRACKING RATE*² | mass % | 52 | 68 | 82 | 33 | 45 |

| | | | | EXAMPLE 6 | EXAMPLE 7 | EXAMPLE 8 | EXAMPLE 9 |
|---|---|---|---|---|---|---|---|
| CONTENT | CONTENT OF SUM OF | (C4−) | mass % | 1.64 | 1.13 | 1.70 | 2.01 |
| OF | HYDROCARBONS | | | | | | |
| HYDROCARBON | HAVING FOUR OR | | | | | | |
| | LESS CARBON ATOMS | | | | | | |
| | NORMAL BUTANE | (nC4) | mass % | 0.34 | 0.23 | 0.35 | 0.42 |
| | ISO-BUTANE | (iC4) | mass % | 0.81 | 0.55 | 0.84 | 0.99 |
| | PROPANE | (C3) | mass % | 0.43 | 0.32 | 0.44 | 0.52 |

| | | | | | |
|---|---|---|---|---|---|
| CRACKING RATE ESTIMATED FROM | mass % | 58.0 | 41.9 | 59.7 | 68.5 |
| HYDROCARBONS HAVING FOUR OR | | | | | |
| LESS CARBON ATOMS*¹ | | | | | |
| ACTUAL CRACKING RATE*² | mass % | 57 | 41 | 57 | 71 |

*¹(EQUATION 1) CRACKING RATE = −3.455 × (C4−)² + 40.933 × (C4−)
*²WAX CRACKING RATE OBTAINED BY SIMULATED DISTILLATION-GAS CHROMATOGRAPHY

### INDUSTRIAL APPLICABILITY

Since the predicted wax cracking rate according to the invention is promptly and accurately obtained, it is easy to control the hydrocracking process of the wax obtained from the FT synthetic oil at an appropriate cracking rate.

Accordingly, the present invention has high applicability in industries including GTL (Gas to Liquid) and petroleum refinery.

1. A method of processing Fischer-Tropsch synthetic oil to manufacture a diesel fuel base stock, the method comprising:
(a) fractionating, in a fractionator, Fischer-Tropsch synthetic oil obtained by a Fischer-Tropsch synthesis method into at least two fractions of a middle fraction containing a component having a boiling point range corresponding to diesel fuel oil and a wax fraction containing a wax component heavier than the middle fraction;
(b) bringing the wax fraction into contact with a hydrocracking catalyst in a hydrocracking reactor to obtain a hydrocracked product;
(c) separating a gas component from the hydrocracked product to produce hydrocracked oil in a gas-liquid separator disposed in the rear of the hydrocracking reactor in the step (b);
(d) measuring the composition of the gas component separated in the step (c);
(e) calculating a cracking rate in the hydrocracking reaction based on the composition of the gas component measured in the step (d); and
(f) controlling an operation condition of the hydrocracking reactor so that the cracking rate calculated in the step (e) agrees with an objective cracking rate.

2. The method according to claim 1, wherein the reaction temperature is in a range of 180 to 400° C., the hydrogen partial pressure is in a range of 0.5 to 12 MPa, and the liquid hourly space velocity is in a range of 0.1 to 10.0 h⁻¹ when the wax fraction is brought into contact with the hydrocracking catalyst in the step (b).

3. The method according to claim 1, wherein, in the step (e), the cracking rate in the hydrocracking reaction is calculated based on a content of hydrocarbons having four or less carbon atoms in the measured composition of the gas component.

4. The method according to claim 1, wherein, in the step (e), the cracking rate in the hydrocracking reaction is calculated based on a content of a sum of hydrocarbons having four or less carbon atoms in the measured composition of the gas component.

5. The method according to claim 1, wherein, in the step (e), the cracking rate in the hydrocracking reaction is calculated based on at least one content of normal butane, iso-butane, and propane in the measured composition of the gas component.

6. The method according to claim 1, wherein, in the step (d), a method of measuring the composition of the gas component is gas chromatography.

7. A method of calculating a cracking rate in hydrocracking a wax fraction obtained by fractionating Fischer-Tropsch synthetic oil in a fractionator, the method comprising:
(a) hydrocracking the wax fraction;
(b) performing a gas-liquid separation on the hydrocracked product;
(c) measuring a composition of a gas component obtained by the gas-liquid separation; and
(d) calculating a cracking rate in the hydrocracking reaction based on the measured composition of the gas component.

8. The method according to claim 7, wherein, in the step (d), the cracking rate in the hydrocracking reaction is calculated based on a content of hydrocarbons having four or less carbon atoms in the measured composition of the gas component.

9. The method according to claim 7, wherein, in the step (d), the cracking rate in the hydrocracking reaction is calculated based on a content of a sum of hydrocarbons having four or less carbon atoms in the measured composition of the gas component.

10. The method according to claim 7, wherein, in the step (d), the cracking rate of the hydrocracking reaction is calculated based on at least one content of normal butane, iso-butane, and propane in the measured composition of the gas component.

11. The method according to claim 7, wherein, in the step (c), a method of measuring the composition of the gas component is gas chromatography.
